(19) United States
(12) Patent Application Publication
(10) Pub. No.: US 2003/0048837 A1
(43) Pub. Date: Mar. 13, 2003

(54) Transmission apparatus, transmission level correcting method and transmission control program

(76) Inventors: Akira Sakai, Yokohama-shi (JP); Hiromi Kubota, Yokohama-shi (JP)

Correspondence Address: STEVENS, DAVIS, MILLER & MOSHER, L.L.P, Suite 850, 1615 L Street, N.W., Washington, DC, 20036, US

(21) Appl. No.: 10/234,335

(22) Filed: Sep. 5, 2002

(30) Foreign Application Priority Data
Sep. 11, 2001 (JP) 2001-275256

(51) Int. Cl. H04B 3/46

(52) U.S. Cl. 375/224

(57) ABSTRACT

During communications between a station apparatus and home apparatus, the station apparatus transmits a test signal TS, the home apparatus having received the test signal recognizes a change in state of a metallic transmission channel in the middle of the communications, estimates an output level suitable for a current state, and requests the station apparatus to transmit data with an estimated output level using a test signal NS, and the station apparatus transmits data with the output level requested from the home apparatus, and thus changes a transmission level set at the time of starting communications to a level corresponding to the change in state.

### BACKGROUND OF THE INVENTION

1. Field of the Invention

The present invention relates to a transmission apparatus, transmission level correcting method and transmission control program for transmitting signals using a plurality of metallic transmission channels adjacent to each other.

2. Description of the Related Art

In recent years, with increases in information amount transmitted via networks, transmission channels have been switched from metallic channels to optical fiber channels. However, since it takes a considerably long time and high cost to complete optical fiber networks, existing metallic transmission channels are supposed to be used for some time.

In such a status, techniques become widespread for providing fast communication services using existing metallic transmission channels. Among these communication services widely known are ISDN and xDSL (x-Digital Subscribe Line). Demands for remotely accessing to computer networks using metallic transmission channels are increased, and in response to such demands, various fast digital data transmission services are provided using existing telephone networks.

In the existing telephone networks, paired wires composed of a plurality of metallic transmission channels are accommodated adjacent to each other in a single cable. When paired wires are assigned in a cable according to service request, assignments of paired wires are distributed generally at random in a cross section of the cable. Since results of paired-wire assignment are usually not recorded correctly, it is difficult to know assignments (distribution states) correctly later.

At branching points and connecting points of cables, lengths of metallic transmission channels differ due to the fact that metallic transmission channels composing paired wires are spaced. Adjacent paired wires with different lengths may cause interference and/or leaks with/between the channels. Further, ham radio signals and AM radio signals have effects on paired wires as incoming noises, and are multiplexed on signals of paired wires of ISDN and PSTN. There are no problems with those interference, leaks and noises in low analog signals, but some problems therewith have begun to arise as the transmission rate is increased.

The assignments of paired wires are distributed at random in a cross section of a cable, and recovery is difficult when interference, leaks and noises have effects only on one of metallic transmission channels with different paired-wire lengths. Then, in order to reduce effects on adjacent metallic transmission channels, there is proposed a method as disclosed in Japanese Laid-Open Patent Publication 2000-13283. That is, a signal transmission apparatus communicates a training signal with a communicating party apparatus at the time of starting communications, determines a minimum transmission level required for transmitting signals on the metallic transmission channel, sets a transmitter for the minimum transmission level, adjusts a signal level of the transmitter always to the minimum transmission level in subsequent data transmission, and thus reduces effects on the adjacent metallic transmission channels.

However, even when the effects are reduced on adjacent metallic transmission channels by adjusting a signal level of a transmitter based on transmission distance, and states of interference, leak and noise at the time of starting communications, the signal level adjusted at the time of starting communications is not a suitable value when states of adjacent metallic transmission channels and the used metallic transmission channel vary after starting communications, and it is not possible to reduce effects due to interference, leaks and noises on the adjacent metallic transmission channels and the used metallic transmission channel.

### SUMMARY OF THE INVENTION

In view of the foregoing, it is an object of the present invention to provide a transmission apparatus, transmission level correcting method and transmission control program capable of reducing interference, leaks and noises on adjacent metallic transmission channels and pertinent transmission channel even when transmission channel states vary on the adjacent metallic transmission channels and pertinent transmission channel after starting communications.

A transmission apparatus of the present invention is provided with a signal transmission section that transmits a test signal with a fixed pattern in the middle of data transmission to any other transmission apparatus connected via a metallic transmission channel, a signal analyzing section that analyzes a content of a signal transmitted from the other transmission apparatus to detect a request output level of a change request, and a level changing section that adjusts a transmission level to the request output level detected in the signal analyzing section.

Further, a transmission apparatus of the present invention is provided with a signal analyzing section that analyzes a state of a test signal with a fixed pattern transmitted in the middle of data transmission from any other transmission apparatus connected via a metallic transmission channel, a judging section that judges whether a transmission level is suitable based on a result analyzed in the signal analyzing section, a determining section that estimates a shortage in output level to determine a request output level when the transmission level is judged not to be suitable, and a notifying section that notifies the other transmission apparatus of the request output level determined in the determining section.

In a transmission level correcting method of the present invention, a transmission apparatus transmits a test signal with a fixed pattern in the middle of data transmission to any other transmission apparatus connected via a metallic transmission channel, analyzes a content of a signal transmitted from the other transmission apparatus to detect a request output level of a change request, and adjusts a transmission level to the detected request output level.

In a transmission level correcting method in the present invention, a transmission apparatus analyzes a state of a test signal with a fixed pattern transmitted in the middle of data transmission from any other transmission apparatus connected via a metallic transmission channel, judges whether a transmission level is suitable based on the analyzed result, estimates a shortage in output level to determine a request output level when the transmission level is judged not to be suitable, and notifies the party transmission apparatus of the determined request output level.

A transmission control program of the present invention is used for a computer to function as a signal transmission section that transmits a test signal with a fixed pattern in the middle of data transmission to any other transmission apparatus connected via a metallic transmission channel, a signal analyzing section that analyzes a content of a signal transmitted from the other transmission apparatus to detect a request output level of a change request, and a level changing section that adjusts a transmission level to the request output level detected in the signal analyzing section.

A transmission control program of the present invention is used for a computer to function as a signal analyzing section that analyzes a state of a test signal with a fixed pattern issued in the middle of data transmission from any other transmission apparatus connected via a metallic transmission channel, a judging section that judges whether a transmission level is suitable based on a result analyzed in the signal analyzing section, a determining section that estimates a shortage in output level to determine a request output level when the transmission level is judged not to be suitable, and a notifying section that notifies the other transmission apparatus of the request output level determined in the determining section.

According to the present invention, a test signal is communicated between transmission apparatuses during communications, whereby in the middle of the communications, one of the apparatuses recognizes a state of the metallic transmission channel, determines an output level to notify the party apparatus, and thus is capable of dynamically changing a transmission level set at the time of starting communications corresponding to current state of the metallic transmission channel. It is thereby possible to reduce interference, leaks and noises on adjacent metallic transmission channels and used metallic transmission channel even when transmission channel states vary on the adjacent metallic transmission channels and used metallic transmission channel after starting communications.

### BRIEF DESCRIPTION OF THE DRAWINGS

The above and other objects and features of the invention will appear more fully hereinafter from a consideration of the following description taken in connection with the accompanying drawing wherein one example is illustrated by way of example, in which;

FIG. 1A,B are a sequence diagram relating to level correction between a station apparatus and home apparatus in a first embodiment of the present invention;

FIG. 2 is a diagram illustrating a system configuration of apparatuses according to first to third embodiments of the present invention;

FIG. 3 is a schematic hardware configuration diagram of the station apparatus or home apparatus in the first to third embodiments of the present invention;

FIG. 4A,B are a sequence diagram relating to level correction between a station apparatus and home apparatus in a second embodiment of the present invention; and

FIG. 5A,B are a sequence diagram relating to level correction between a station apparatus and home apparatus in a third embodiment of the present invention.

### DETAILED DESCRIPTION OF THE PREFERRED EMBODIMENTS

Embodiments of the present invention will be described below specifically with reference to accompanying drawings.

(First Embodiment)

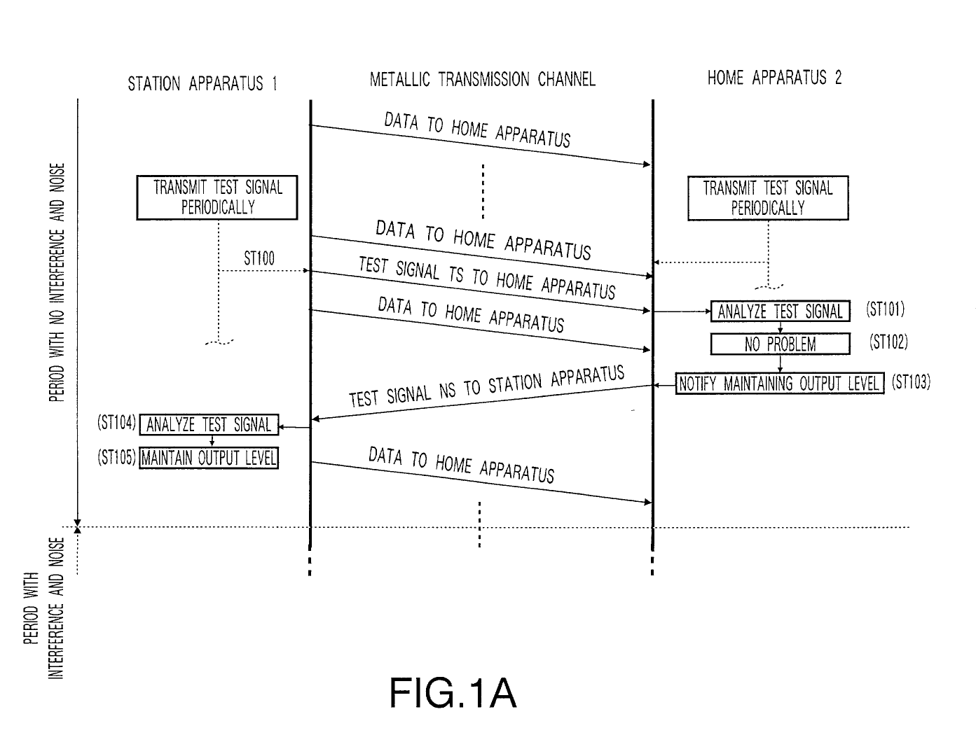

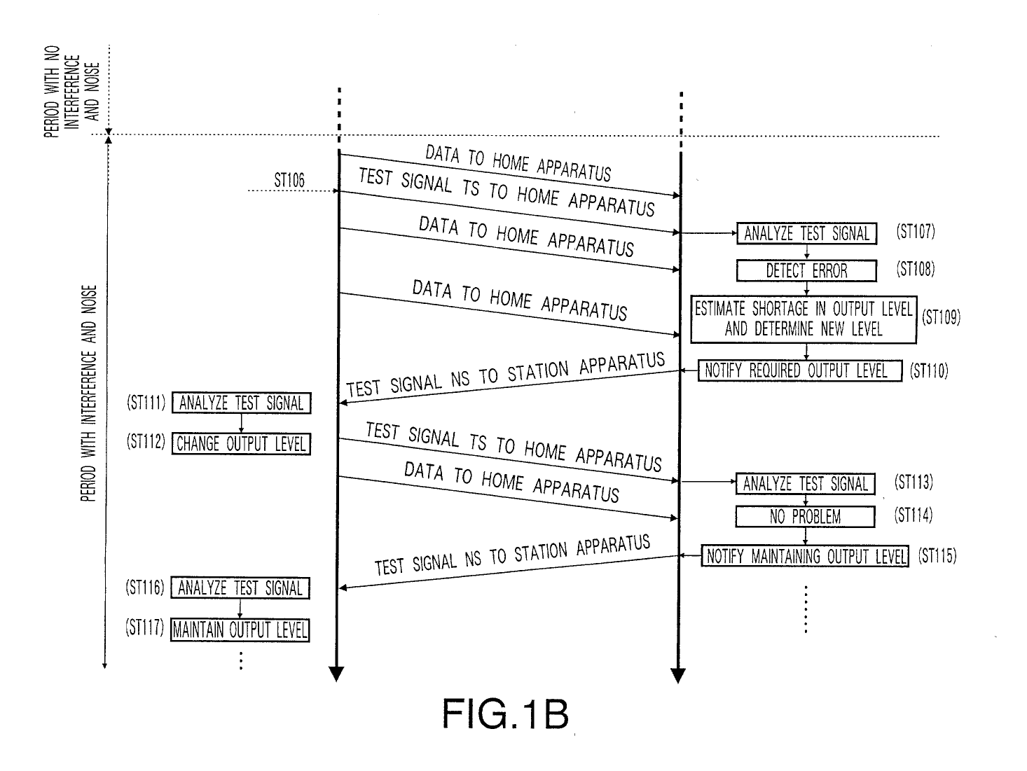

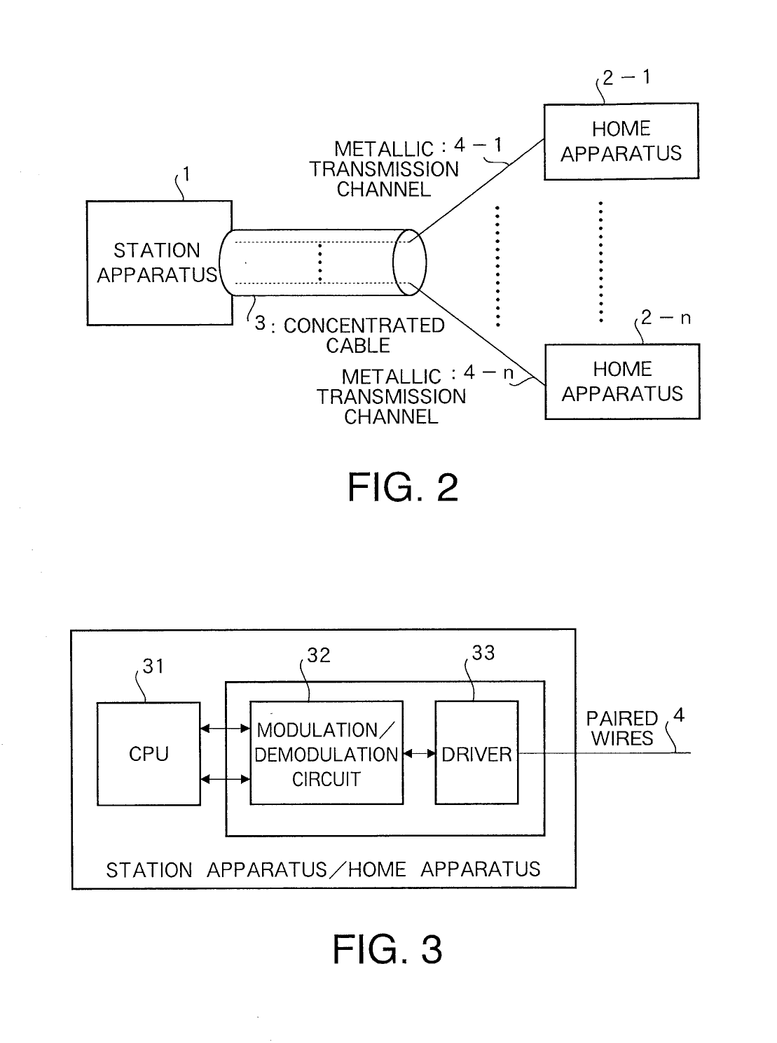

FIG. 1A,B are a sequence diagram between station apparatus 1 and home apparatus 2, and FIG. 2 is a diagram illustrating a schematic system configuration of apparatuses according to this embodiment. As shown in FIG. 2, station apparatus 1 is connected to home apparatuses 2-1 to 2-n via concentrated cable 3, resulting in a system configuration enabling data transmission between apparatus 1 and apparatuses 2. Metallic transmission channels 4-1 to 4-n are concentrated in concentrated cable 3, and are collectively accommodated in a single cable at least in the vicinity of the station apparatus.

In concentrated cable 3, signals interfere with each other which are transmitted via metallic transmission channel 4 accommodated in the same quad and adjacent quads, and multiplexed noises caused by signals of ISDN, PSTN, etc. and incoming noises caused by AM radio and ham radio signals due to wiring environments are multiplexed and transmitted on metallic transmission channel 4. Such noises occur as stationary or occasional noises at various bands with various signal levels.

FIG. 3 is a block diagram illustrating a schematic hardware configuration common to station apparatus 1 and home apparatuses 2-1 to 2-n. CPU 31 executes a transmission control program and thereby implements transmission level correction described later. Bit data output from CPU 31 is input to modulation/demodulation circuit 32, converted into an analog signal, and modulated with a predetermined modulation scheme, and the resultant signal is transmitted to metallic transmission channel 4 composing the paired wires from driver 33. A signal incoming from metallic transmission channel 4 is detected in driver 33, and converted into bit data in modulation/demodulation circuit 32, and the bit data is provided to CPU 31 to be processed.

In a sequence illustrated in FIG. 1A,B, a training sequence is omitted which is performed at the time power is supplied. In other words, when home apparatus 2 (n home apparatuses, i.e. 2-1 to 2-n, are collectively called “home apparatus 2”) is turned on and connected to station apparatus 1, the apparatus 2 transmits a training signal with a predetermined transmission level and bit pattern to station apparatus 2, before starting actual data transmission. When analyzing the signal received from home apparatus 2 and determining that the signal is the training, station apparatus 1 detects a signal level of the received training signal, notifies home apparatus 2 of a transmission level corresponding to the detected signal level, and thereby instructs to decrease a level of a signal transmitted over metallic transmission channel 4 from home apparatus to a minimum level required for transmission. In this embodiment CPU 31 illustrated in FIG. 3 provides a control signal to modulation/demodulation circuit 32, and thus adjusts the transmission level. The adjustment of the transmission level in home apparatus is performed in the same way.

Meanwhile, when the channel is connected between station apparatus 1 and home apparatus 2, station apparatus 1 also transmits a training signal with a predetermined transmission level and bit pattern, before starting actual data transmission. Home apparatus 2 also detects a signal level of the training signal, notifies station apparatus 1 of a transmission level of station apparatus 1 corresponding to the detected signal level, and thereby instructs to decrease a level of a signal transmitted over metallic transmission channel 4 from station apparatus 1 to a minimum level required for transmission.

As described above, at the time of starting communications, station apparatus 1 and home apparatus 2 both adjust transmission levels by transmitting and receiving the training signal, and decrease the transmission level to a minimum level that maximizes the suppression of interference and leaks under circumstance that communications are started.

With reference to FIG. 1A,B, operations will be described specifically below which are performed in station apparatus 1 and home apparatus 2 in data transmission. In FIG. 1A,B the first half is indicative of a sequence when interference or the like does not occur, and the latter half is indicative of a sequence when interference or the like occurs.

Operations in the first half where interference does not occur will be described first. Station apparatus 1 executes data transmission based on the transmission level determined at the time of starting communications. Then, at appropriate intervals during the data transmission, station apparatus 1 transmits a test signal TS to home apparatus 2 based on the transmission level determined at the time of starting communications (ST100). The test signal TS is composed of a predetermined known pattern, and has a frequency spectrum corresponding to frequency spectrum of a transmission signal used in the data transmission. By thus providing the test signal TS with the frequency spectrum corresponding to the frequency spectrum of the transmission signal, it is possible to examine channel states over the transmission band.

Meanwhile, although FIG. 1A,B illustrates part of procedures, home apparatus 2 also transmits a test signal NS at appropriate intervals as station apparatus 1. The test signal NS issued from home apparatus 2 is also composed of a predetermined known pattern, and has a frequency spectrum corresponding to frequency spectrum of a transmission signal used in the data transmission.

When receiving the test signal TS issued from station apparatus in the middle of data communications, home apparatus 2 analyzes the test signal TS (ST101), and determines whether a transmission error occurs on metallic transmission channel 4 (ST102). When the test signal TS is affected by interference or the like on metallic transmission channel 4, since a content (bit pattern) of the signal, signal level and frequency spectrum vary, by examining these factors a receiving side is capable of detecting the occurrence of transmission error, or of detecting that effects of adjacent metallic transmission channel, multiplexed noise due to ISDN or the like, and incoming noise have varied.

Since it is assumed herein that no transmission error occurs, the processing in ST1101 determines “no problem”. As a result of analyzing the received test signal TS, it is confirmed that transmission error does not occur, or effects do not change, home apparatus 2 notifies station apparatus 1 of maintaining the current output level using the test signal NS issued at appropriate intervals (ST103).

Station apparatus 1 analyzes the test signal NS (ST104), and determines whether or not to require transmission level adjustment (ST105). As described above, when the test signal NS instructs to maintain the current output level, station apparatus 2 confirms that any transmission error does not occur or effects do not change, and maintains the current output level as a transmission level of data transmissions to home apparatus 2.

Operations in the latter half where interference or the like occurs on metallic transmission channel 4 will be described. When channel states change and interference or the like occurs on metallic transmission channel 4 after determining the communication level at the time of starting communications, the test signal TS is affected by the change and a content, signal level and/or frequency spectrum of the signal changes. More specifically, since the test signal TS has a known fixed pattern, a pattern of the received signal TS is compared with the known pattern stored at the receiving side, and it is determined whether the content of the signal changes from the degree of matching between patterns. Further, in the case of multi-carrier communications such as an ADSL scheme, since received levels change for each carrier corresponding to channel state, it is possible to detect changes in channel state with respect to all the carriers by comparing the frequency spectrum obtained when the transmission level was last determined with the frequency spectrum of the test signal TS currently received. Further, also in the case of single-carrier communications, since the frequency spectrum varies corresponding to channel state, comparing frequency spectra detects a change in effect as in multi-carrier communications.

Station apparatus 1 transmits the test signal TS at appropriate intervals to home apparatus 2, and as illustrated in FIG. 1A,B, transmits the test signal TS to home apparatus 2 also during a period in which interference or the like occurs on metallic transmission channel 4 ST106).

The test signal TS issued from station apparatus 1 in ST106 is affected by the interference or the like on metallic transmission channel 4, and causes changes in its content, level and frequency spectrum. Home apparatus 2 having received such a test signal TS analyzes the signal TS (ST107), and detects that a transmission error or effect change occurs on metallic transmission channel 4 (ST108). When detecting that a transmission error or effect change occurs on metallic transmission channel 4, based on the change in signal level or frequency spectrum home apparatus 2 estimates a transmission output level lacking to reduce effects of interference and/or noises on signal transmission, and determines a new suitable transmission level (ST109). Then, using the test signal NS issued to station apparatus 1, home apparatus 2 notifies the apparatus 1 of an output level change request and transmission level determined in ST109 as a required output level (ST110).

Meanwhile, station apparatus 1 analyzes the test signal NS issued from home apparatus 2 in ST110 (ST111), recognizes the output level change request and required output level, and changes an output level of station apparatus 1 to the notified output level (ST112). Station apparatus 1 continues to transmit data and test signal TS with the changed output level after changing the output level.

Home apparatus 2 analyzes the test signal TS with the changed output level (ST113), and determines whether a change in output level is needed (ST114). As an example illustrated in FIG. 1A,B, when home apparatus 2 determines no need of changing the output level, the apparatus 2 issues the test signal NS for instructing to maintain the current output level (ST115). Station apparatus 1 analyzes the test signal NS issued in ST115 (ST116), confirms that maintaining the current output level is instructed, and maintains the output level (ST117).

Thus, according to this embodiment, station apparatus 1 and home apparatus 2 mutually transmit and receive test signals TS and NS for checking states of metallic transmission channel 4 at appropriate intervals during communications, thereby perform correction of transmission level on the transmission channel corresponding to effects of adjacent metallic transmission channels on metallic transmission channel 4 used in the communications, of multiplexed noises due to ISDN, PSTN, etc. on the metallic transmission channel 4 after starting communications, and/or of incoming noises due to AM radio, ham radio, etc. on the metallic transmission channel 4 after starting communications, and transmit signals with a minimum transmission level corresponding to the effects even when the effects change after starting communications. It is thereby possible to suppress effects on adjacent metallic transmission channels to a minimum, reduce effects of adjacent metallic transmission channels having changed after starting communications, of multiplexed noises due to ISDN, PSTN, etc. on the metallic transmission channel 4, and of incoming noises due to AM radio, ham radio, etc., and transmit signals always on a stable metallic transmission channel without degrading a data transmission rate caused by a change in modulation density (decreases in the number of symbols, sub-carrier off, etc.) incorporated into transmission protocols for ADSL, etc.

In addition, while the case is explained above that station apparatus 1 transmits data to home apparatus 2 and metallic transmission channel 4 changes from a state with no interference and no noise to a state with interference and/or noises, the present invention is applicable in the same way to cases where metallic transmission channel 4 changes from a state with interference and/or noises to a state with no interference and no noise and where on metallic transmission channel 4 interference and/or noise appears and disappears repeatedly.

(Second Embodiment)

The second embodiment will be described below. While in the first embodiment station apparatus 1 and home apparatus 2 automatically transmit and receive test signals TS and NS at appropriate intervals, in this embodiment when an error amount detected in the transmission protocol exceeds a threshold, one of the apparatuses requests the other apparatus to issue a test signal. In addition, a system configuration of station apparatus 1 and home apparatus 2 (FIG. 2) and a schematic hardware configuration (FIG. 3) are the same as in the first embodiment, and operations associated with the issue of test signal in station apparatus 1 and home apparatus 2 is explained specifically herein.

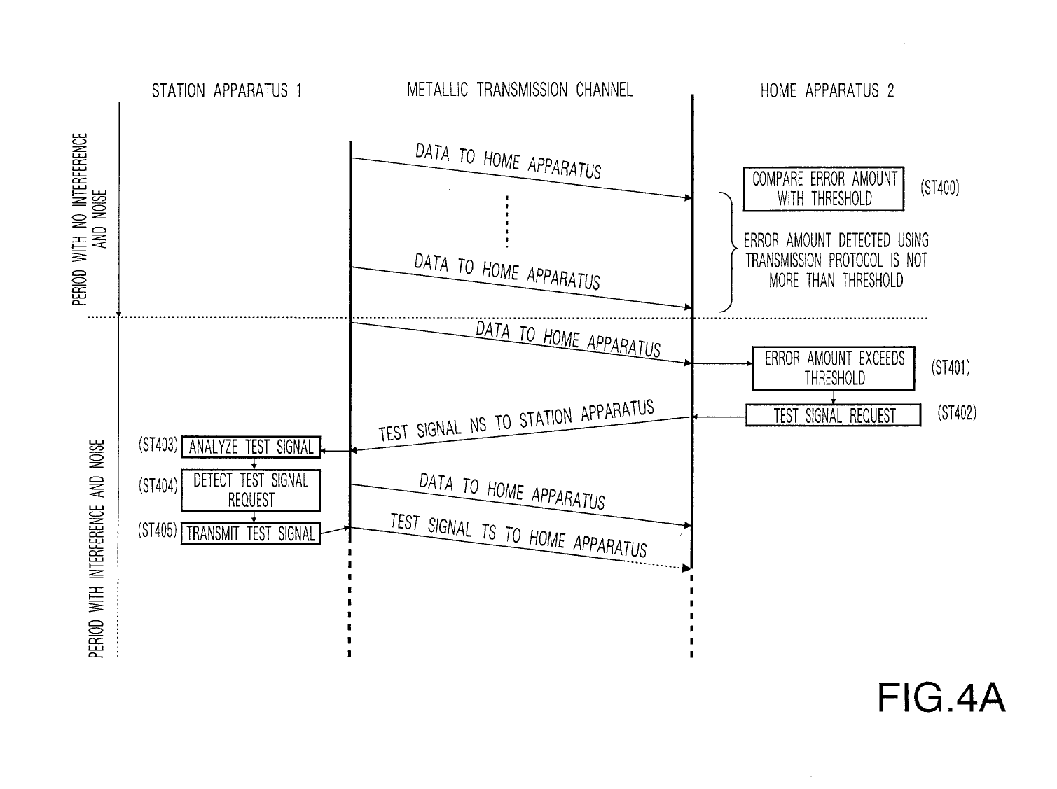

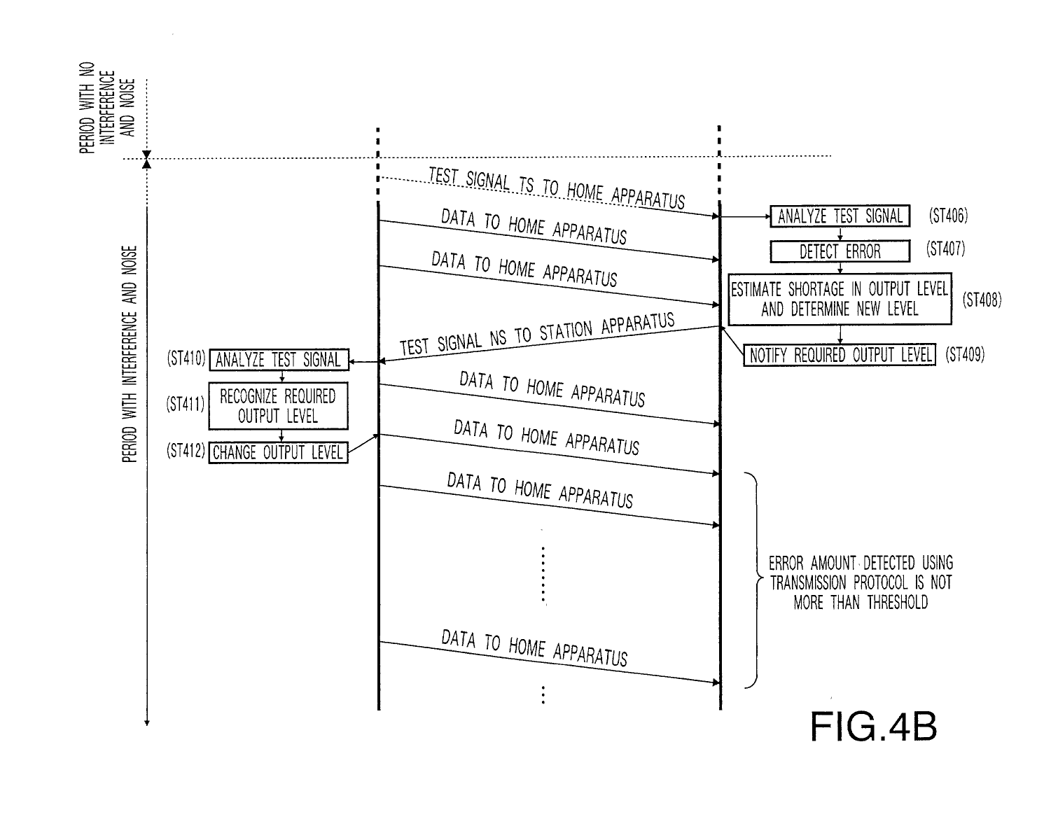

With reference to FIG. 4A,B, operations in station apparatus 1 and home apparatus 2 in data transmission will be described specifically. In FIG. 4A,B the first half is indicative of a sequence when interference or the like does not occur, and the latter half is indicative of a sequence when interference or the like occurs.

Operations in the first half where interference or the like does not occur will be described first. Station apparatus 1 and home apparatus 2 do not issue test signals TS and NS until a test signal request described later is received. Transmission levels of station apparatus 1 and home apparatus 2 are adjusted to a minimum transmission level required for data transmission, by training at the time of starting communications.

Station apparatus 1 performs data transmission with a previously determined transmission level. Home apparatus 2 receives signals from station apparatus 1, while detecting an error amount occurring in data transmission with the transmission protocol. In addition, while in this embodiment detection of error is dependent on the transmission protocol, it may be possible to provide a specific error detecting function which is not dependent on the transmission protocol. Home apparatus 2 compares the detected error amount with a threshold, and determines whether the error amount exceeds the threshold (ST400). Home apparatus 2 makes such a determination at predetermined intervals or on a predetermined data basis.

When an error occurs on metallic transmission channel 4 or effects change after last determining a transmission level, since the current apparatus setting (transmission level) does not match the current channel state, it is expected an error amount increases as a result of mismatching.

Then, as a result of comparing the error amount with threshold in ST401, when it is determined that the error amount is not more than the threshold, data communications with the last determined transmission level are continued. Meanwhile, when it is determined that the error amount exceeds the threshold (ST401), home apparatus 2 transmits a test signal request to station apparatus 1 for the first time (ST402). In this embodiment, using the same test signal NS as in the first embodiment, home apparatus 2 notifies station apparatus 1 of the test signal request.

Thus, since home apparatus 2 does not issue the test signal NS until the error amount exceeds the threshold, there is effectiveness of reducing loads on home apparatus 2 as compared with the case where the apparatus 2 issues the test signal NS periodically independent of the presence or absence of error occurrence or effect change on metallic transmission channel 4.

Meanwhile, station apparatus 2 analyzes the test signal NS issued from home apparatus 2 in ST402 (ST403), and recognizes that home apparatus 2 notifies the test signal request from the analyzed result (ST404). The test signal request may be provided with bit data of a predetermined field. When detecting the test signal request, station apparatus 1 issues the test signal TS with the last determined transmission level (ST405). In addition, the test signal TS issued from station apparatus 1 is assumed to be the same as in the first embodiment.

Thus, since station apparatus 1 issues the test signal TS only when detecting the test signal request, there is effectiveness of reducing loads on station apparatus 1 as compared with the case where station apparatus 1 issues the test signal TS at appropriate intervals without awaiting a request from home apparatus 2.

Home apparatus 2 analyzes the signal TS issued from station apparatus 1 (ST406), and determines whether a transmission error or effect change occurs on metallic transmission channel 4 as in the first embodiment (ST407). When detecting a transmission error or effect change on metallic transmission channel 4 as a result of the determination in ST407, home apparatus 2 estimates a shortage in output level, determines an output level corresponding to current state of metallic transmission channel 4(ST408), and using the test signal NS, transmits to station apparatus 1 a transmission output level change request and newly determined transmission level (ST409).

Since the test signal TS analyzed in ST406 is issued in response to the test signal request generated by home apparatus 2 when the error amount exceeds the threshold, such a signal has a high possibility that a content, signal level and/or frequency spectrum of the signal changes. Accordingly, since the possibility becomes extremely high that a transmission error or effect change on metallic transmission channel 4 is detected from the result analyzed in ST406, the transmission level is corrected at a high possibility when performing analysis in ST406 and determination in ST407, and therefore efficient processing is achieved.

Meanwhile, when station apparatus 1 analyzes the test signal NS (ST410), detects a transmission output level change request, and recognizes a newly determined transmission level (ST411), the apparatus 1 changes the transmission level of a signal to the new transmission level requested from home apparatus 2 (ST412), and uses the changed transmission level in subsequent signal transmission.

Thus, according to this embodiment, an error amount is detected in the transmission protocol during communications between station apparatus 1 and home apparatus 2, and only when the error amount exceeds a predetermined threshold, test signals TS and NS are transmitted and received. Then, based on the test signals, a transmission level on the transmission channel is corrected corresponding to interference from adjacent metallic transmission channels on metallic transmission channel 4 used in the communications, effect of multiplexed noises due to ISDN, PSTN, etc. on the metallic transmission channel 4, and/or effect of incoming noises due to AM radio, ham radio, etc. Thus, the test signals TS and NS are communicated only when the transmission channel state changes, and it is thereby possible to decrease the number of times a receiving side analyzes the test signal and the number of times a transmitting side transmits the test signal.

In addition, while the case is explained above that station apparatus 1 transmits data to home apparatus 2 and metallic transmission channel 4 changes from a state with no interference and no noise to a state with interference and/or noises, the present invention is applicable in the same way to cases where metallic transmission channel 4 changes from a state with interference and/or noises to a state with no interference and no noise and where on metallic transmission channel 4 interference and/or noise appears and disappears repeatedly.

(Third Embodiment)

The third embodiment of the present invention will be described. While in the first embodiment station apparatus 1 and home apparatus 2 automatically transmit and receive test signals TS and NS at appropriate intervals, in this embodiment the apparatuses issue test signals using a period during which data is not transmitted. In addition, a system configuration of station apparatus 1 and home apparatus 2 (FIG. 2) and a schematic hardware configuration (FIG. 3) are the same as in the first embodiment, and operations associated with the issue of test signal in station apparatus 1 and home apparatus 2 is explained specifically herein.

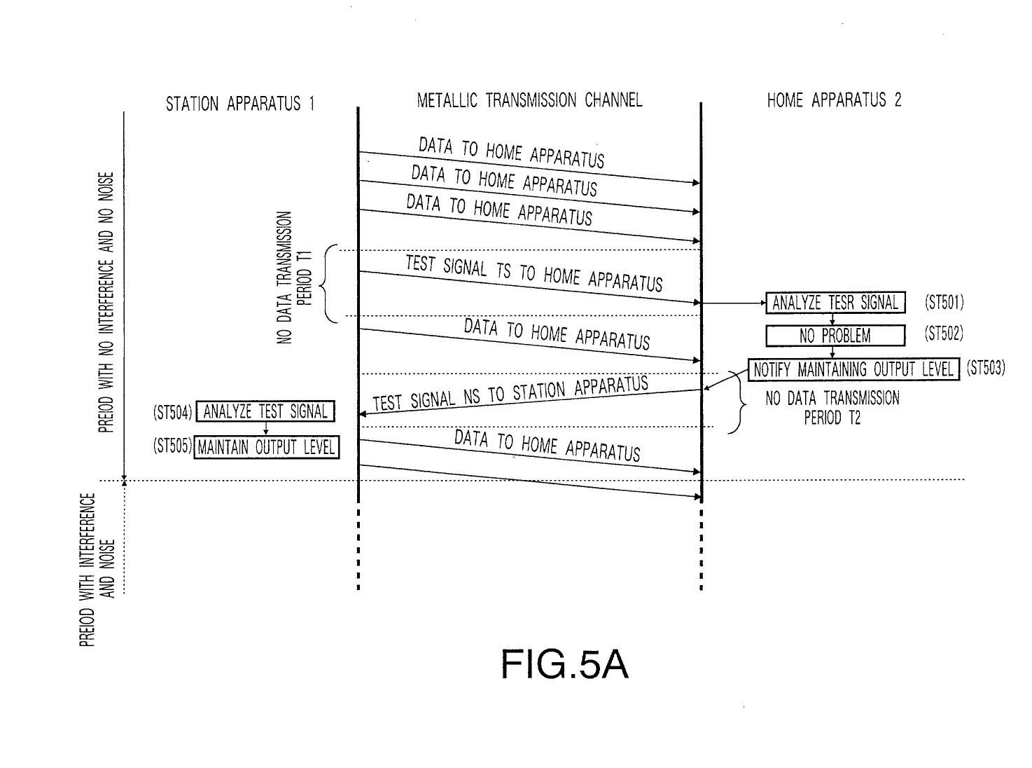

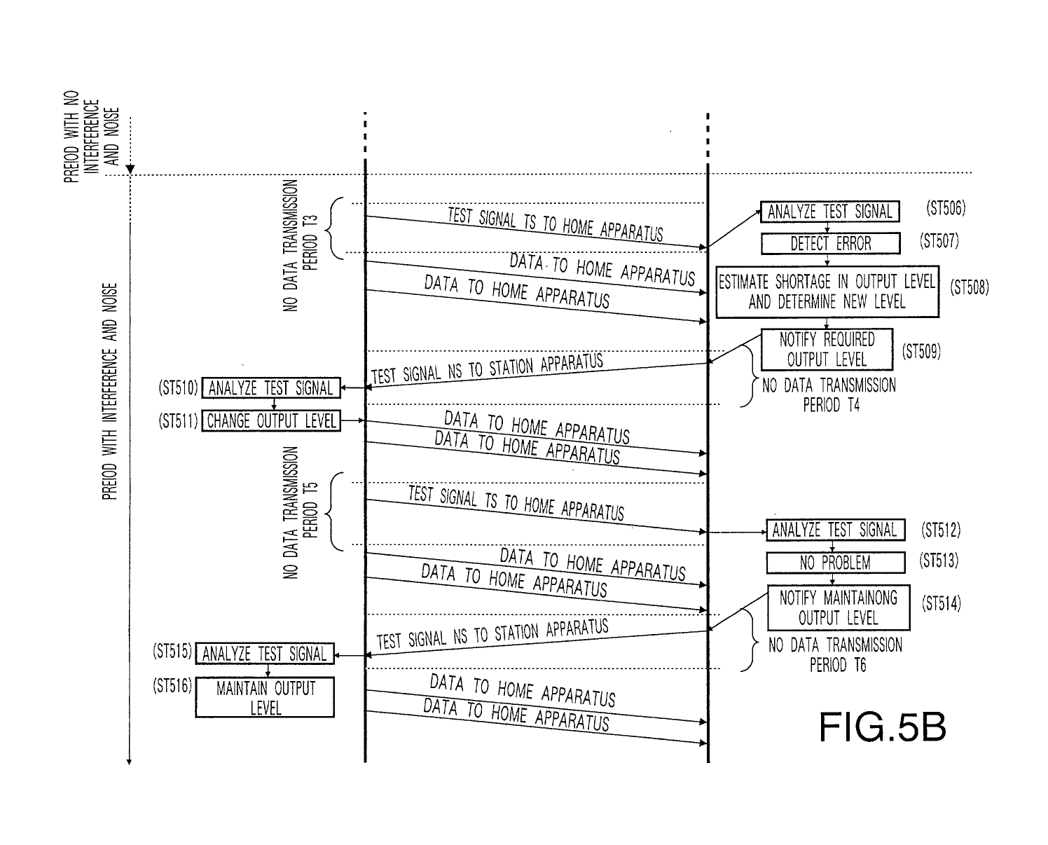

With reference to FIG. 5A,B, operations in station apparatus 1 and home apparatus 2 in data transmission will be described specifically. In FIG. 5A,B the first half is indicative of a sequence when interference or the like does not occur, and the latter half is indicative of a sequence when interference or the like occurs.

Operations in the first half where interference or the like does not occur will be described first. Station apparatus 1 and home apparatus 2 do not issue test signals TS and NS until no data transmission period T1 or T2. Transmission levels of station apparatus 1 and home apparatus 2 are adjusted to a minimum level required for data transmission, by training at the time of starting communications.

Station apparatus 1 executes data communications with the transmission level determined by training at the time of starting communications, and when a time with no data transmission arises (period T1), issues the test signal TS during the period T1. The test signal TS is assumed to be the same as in the first embodiment.

Home apparatus 2 analyzes the test signal TS issued from station apparatus 1 (ST151), and determines whether a transmission error or effect change occurs on metallic transmission channel 4 (ST502). Since it is assumed herein that no transmission error occurs, “no problem” is determined. Then, home apparatus 2 waits for a time with no data transmission to come. At the time with no data transmission (period T2), using the test signal NS, home apparatus 2 notifies “maintaining an output level” to instruct station apparatus 1 to maintain the current output level (ST503). In addition, the test signal NS is assumed to be the same as in the first embodiment.

Station apparatus 1 analyzes the test signal NS issued from home apparatus 2 (ST504), and when recognizing “maintaining an output level”, determines to maintain the current output level (ST505).

When no data transmission period T3 that is a time with no data transmission arises, station apparatus 1 issues the test signal TS to home apparatus 2. At this point, if interference or the like occurs on metallic transmission channel 4, the test signal TS with a changed content, signal level and/or frequency spectrum is received in home apparatus 2.

When home apparatus 2 analyzes the test signal issued at the time a transmission error or the like occurs (ST506), the apparatus 2 determines that the transmission error occurs on metallic transmission channel 4 from changes in its content, level and frequency spectrum (ST507). When detecting that transmission error or effect change occurs on metallic transmission channel 4, based on the change in signal level or frequency spectrum home apparatus 2 estimates a transmission output level lacking to reduce effects of interference or noises on signal transmission, and determines a new suitable transmission level (ST508). Then, home apparatus 2 waits for next no data transmission time to come, and at the time of no data transmission period T4 that is the next no data transmission time, using the test signal NS, notifies the apparatus 1 of an output level change request and transmission level determined in ST508 as a required output level (ST509).

Meanwhile, station apparatus 1 analyzes the test signal NS issued from home apparatus 2 in ST509 (ST510), recognizes the output level change request and required output level, and changes an output level of station apparatus 1 to the notified output level (ST511). Station apparatus 1 performs data transmission with the notified output level, and during no data transmission period T5 that is next no data transmission time, transmits the test signal TS again.

Home apparatus 2 analyzes the test signal TS with the changed output level (ST512), and determines whether a change in output level is needed (ST513). As an example illustrated in FIG. 5A,B, when determining no need of changing the output level, home apparatus 2 finds no data transmission period T6 that is next no data transmission time, and issues the test signal NS for instructing to maintain the current output level (ST514). Station apparatus 1 analyzes the test signal NS issued in ST514 (ST516), confirms that maintaining the current output level is instructed, and maintains the output level (ST516).

Thus, according to this embodiment, station apparatus 1 and home apparatus 2 transmit and receive test signals TS and NS only when no data transmission time arises during communications. Then, based on the test signals, a transmission level on the transmission channel is corrected corresponding to interference from adjacent metallic transmission channels on metallic transmission channel 4 used in the communications, effect of multiplexed noises due to ISDN, PSTN, etc. on the metallic transmission channel 4, and/or effect of incoming noises due to AM radio, ham radio, etc., whereby it is possible to perform signal level correction without providing effects on communication traffic.

In addition, while the case is explained above that station apparatus 1 transmits data to home apparatus 2 and metallic transmission channel 4 changes from a state with no interference and no noise to a state with interference and/or noises, the present invention is applicable in the same way to cases where metallic transmission channel 4 changes from a state with interference and/or noises to a state with no interference and no noise and where on metallic transmission channel 4 interference and/or noise appears and disappears repeatedly.

The present invention is not limited to the above described embodiments, and various variations and modifications may be possible without departing from the scope of the present invention.

This application is based on the Japanese Patent Application No. 2001-275256 filed on Sep. 11, 2001, entire content of which is expressly incorporated by reference herein.

Industrial Availability

The present invention is applicable to radio apparatuses mounted on mobile station apparatuses and base station apparatuses in mobile communication systems.

What is claimed is:

1. A transmission apparatus comprising:
a signal transmission section that transmits a test signal with a fixed pattern in the middle of data transmission to any other transmission apparatus connected via a metallic transmission channel;
a signal analyzing section that analyzes a content of a signal transmitted from the other transmission apparatus to detect a request output level of a change request; and
a level changing section that adjusts a transmission level to the request output level detected in the signal analyzing section.

2. A transmission apparatus comprising:
a signal analyzing section that analyzes a state of a test signal with a fixed pattern transmitted in the middle of data transmission from any other transmission apparatus connected via a metallic transmission channel;
a judging section that judges whether a transmission level is suitable based on a result analyzed in the signal analyzing section;
a determining section that estimates a shortage in output level to determine a request output level when the transmission level is judged not to be suitable; and
a notifying section that notifies the other transmission apparatus of the request output level determined in the determining section.

3. The transmission apparatus according to claim 2, further comprising:
a test signal requesting section that generates a test signal request when an error amount detected using a transmission protocol exceeds a threshold in the middle of data transmission from the other transmission apparatus,
wherein the signal analyzing section analyzes a state of the test signal with the fixed pattern transmitted from the other transmission apparatus in response to the test signal request.

4. The transmission apparatus according to claim 1, wherein the signal transmission section transmits the test signal with the fixed pattern when the signal analyzing section detects the test signal request.

5. The transmission apparatus according claim 1, wherein the signal transmission section tranmits the test signal with the fixed pattern to the other transmission apparatus when a time with no data transmission arises.

6. The transmission apparatus according claim 2, wherein the notifying section notifies the other transmission apparatus of the request output level determined in determining section when a time with no data transmission arises.

7. The transmission apparatus according to claim 2, wherein the notifying section notifies an instruction for maintaining an output level when the judging section judges the transmission level is suitable.

8. A method of correcting a transmission level, comprising:
transmitting a test signal with a fixed pattern in the middle of data transmission to any other transmission apparatus connected via a metallic transmission channel;
analyzing a content of a signal transmitted from the other transmission apparatus to detect a request output level of a change request; and
adjusting a transmission level to the detected request output level.

9. A method of correcting a transmission level, comprising:
analyzing a state of a test signal with a fixed pattern transmitted in the middle of data transmission from any other transmission apparatus connected via a metallic transmission channel;
judging whether a transmission level is suitable based on the analyzed result;
estimating a shortage in output level to determine a request output level when the transmission level is judged not to be suitable; and
notifying the other transmission apparatus of the determined request output level.

10. The method according to claim 9, wherein a test signal request is generated when an error amount detected using a transmission protocol exceeds a threshold in the middle of data transmission from the other transmission apparatus.

11. The method according to claim 8, wherein when analyzing a content of a signal transmitted from the other transmission apparatus in the middle of data transmission detects a test signal request, the test signal with the fixed pattern is transmitted.

12. The method according to claim 8, wherein the test signal with the fixed pattern is transmitted to the other transmission apparatus when a time with no data transmission arises.

13. The method according to claim 9, wherein the determined request output level is notified to the other transmission apparatus when a time with no data transmission arises.

14. A transmission control program used in providing a computer with functions of:
a signal transmission section that transmits a test signal with a fixed pattern in the middle of data transmission to any other transmission apparatus connected via a metallic transmission channel;
a signal analyzing section that analyzes a content of a signal transmitted from the other transmission apparatus to detect a request output level of a change request; and
a level changing section that adjusts a transmission level to the request output level detected in the signal analyzing section.

15. A transmission control program used in providing a computer with functions of:
a signal analyzing section that analyzes a state of a test signal with a fixed pattern transmitted in the middle of data transmission from any other transmission apparatus connected via a metallic transmission channel;
a judging section that judges whether a transmission level is suitable based on a result analyzed in the signal analyzing section;
a determining section that estimates a shortage in output level to determine a request output level when the transmission level is judged not to be suitable; and
a notifying section that notifies the other transmission apparatus of the request output level determined in the determining section.
